(19) United States
(12) Patent Application Publication
(10) Pub. No.: US 2012/0102185 A1
(43) Pub. Date: Apr. 26, 2012

(54) RESOURCE MANAGEMENT OF SERVER HOSTS IN ONLINE GAME ENVIRONMENT

(75) Inventor: Brian Fernandes, San Diego, CA (US)

(73) Assignee: SONY COMPUTER ENTERTAINMENT AMERICA INC., Foster City, CA (US)

(21) Appl. No.: 12/908,740

(22) Filed: Oct. 20, 2010

(51) Int. Cl. G06F 15/16

(52) U.S. Cl. 709/224

(57) ABSTRACT

Managing resources of server hosts in an online game environment, including: monitoring metrics data of the online game environment including configurable thresholds and rules defined for a game title; processing and analyzing the metrics data; determining whether the metrics data indicates an over or under capacity of the server hosts in the online game environment; sending a first request to locate, deploy, connect, and register additional game servers to the online game environment to support increasing load, when the metrics data indicates the under capacity of the server hosts; and sending a second request to isolate, remove, disconnect, and un-register surplus game servers from the online game environment to make them available to support the player load in other game titles, when the metrics data indicates the over capacity of the server hosts. Keywords include resource management, online gaming, and server architecture.

### BACKGROUND

1. Field of the Invention

The present invention relates to online game servers, and more specifically, to resource management of server hosts in an online game environment.

2. Background

With the recent explosive growth of online games, some online game titles have experienced a very high demand for their services. Many popular game titles have initially deployed many game servers to adequately service the demand. It is not uncommon for 100 or more servers to be dedicated to a given online game title. However, over time, the demand may significantly increase or decrease which causes problems for the resource management of online game servers.

### SUMMARY

The present invention provides for managing resources of server hosts in an online game environment.

In one implementation, a method of managing resources of server hosts in an online game environment is disclosed. The method includes: monitoring metrics data of the online game environment including configurable thresholds and rules defined for a game title; processing and analyzing the metrics data; determining whether the metrics data indicates an over or under capacity of the server hosts in the online game environment; sending a first request to locate, deploy, connect, and register additional game servers to the online game environment to support increasing load, when the metrics data indicates the under capacity of the server hosts; and sending a second request to isolate, remove, disconnect, and un-register surplus game servers from the online game environment to make them available to support the player load in other game titles, when the metrics data indicates the over capacity of the server hosts.

In another implementation, a resource management system to manage resources of server hosts in an online game environment is disclosed. The system includes: an online game environment controller configured to monitor and track players, games, and game servers in the online game environment, wherein the online game environment controller supports external requests to change the state of the online game environment; an online game environment monitoring and data collection service configured to monitor and collect system metrics data related to server loading; an auto-scaling controller configured to process and analyze the system metrics data, and to make scaling decisions based on configurable thresholds and rules defined on a per-game-title basis; and a server deployment service configured to control deployment, initiation, and termination of the game servers.

In yet another implementation, a non-transitory tangible storage medium storing a computer program for managing resources of server hosts in an online game environment is disclosed. The computer program includes executable instructions that cause a computer to: monitor metrics data of the online game environment including configurable thresholds and rules defined for a game title; process and analyze the metrics data; determine whether the metrics data indicates an over or under capacity of the server hosts in the online game environment; send a first request to locate, deploy, connect, and register additional game servers to the online game environment to support increasing load, when the metrics data indicates the under capacity of the server hosts; and send a second request to isolate, remove, disconnect, and un-register surplus game servers from the online game environment to make them available to support the player load in other game titles, when the metrics data indicates the over capacity of the server hosts.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a block diagram of a resource management system for managing resources of server hosts in an online game environment in accordance with one implementation of the present invention.

FIG. 2 is a flowchart illustrating a process for managing resources of server hosts in an online game environment, in particular, an auto-scaling up process, in accordance with one implementation of the present invention.

FIG. 3 is a block diagram of a resource management system for managing resources of server hosts in an online game environment in accordance with another implementation of the present invention.

FIG. 4 is a flowchart illustrating a process for managing resources of server hosts in an online game environment, in particular, an auto-scaling down process, in accordance with one implementation of the present invention.

FIG. 5A illustrates a representation of a computer system and a user.

FIG. 5B is a functional block diagram illustrating the computer system hosting the resource management system.

### DETAILED DESCRIPTION

Certain implementations as disclosed herein provide for managing resources. In one implementation, a resource management system manages resources of server hosts in an online game environment. In another implementation, a resource management system manages online game environment which includes a collection of networked game hosts that supports an online game title. The online game environment includes, but not be limited to, arcade games, simulations, massively multi-player online games (MMOG), virtual reality, avatar communications, interactive television overlays, and games with motion sensing and on various devices. Further, these games, devices, and concepts are considered to be included in the online game environment whether such games, devices, and concepts provide or contribute to, in full or part, an entertainment or simulation experience.

After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

In general, hosting costs are directly proportional to the number of servers required over the life of a game title. However, the number of servers required changes significantly over the life of a game title, usually peaking within the first few weeks of a game launch, and then dropping off thereafter. If the number of hosts required changes after the launch, then the number should be increased or decreased depending on the capacity.

In one implementation, a resource management system provides a real-time auto scaling solution of the most costly component of online gaming client/server architecture, which handles all in-game traffic between gaming clients. A large-scale online game title can typically require over 100 dedicated game server hosts to be deployed at launch. The system can include a controller that monitors system metrics from multiple sources. Based on a programmable set of criteria, the controller can either scale up or scale down game server hosts in real-time. The real-time scaling of the game server hosts provides near optimal conditions for the online game environment and promotes increased sharing of host resources between multiple titles.

Further, the system can substantially reduce the chances that the online players are affected by the real-time auto scaling operations. For example, when scaling down hosts, the controller can send commands to isolate specific hosts to be de-commissioned, and the hosts are initially removed from the pool of hosts maintained by the controller. When all in-progress games have completed on these hosts and they are confirmed idle, the hosts are shut down.

In another implementation, the management of resources of server hosts in an online game environment involves monitoring the system metrics of the online game environment including configurable thresholds and rules defined for a game title. In one example, the thresholds and rules defined for a game title include a player count. The management also involves processing and analyzing the metrics data, and determining whether the metrics data indicates an over or under capacity of the server hosts. When the metrics data indicates the under capacity of the server hosts, a request is sent to locate, deploy, connect, and register additional game servers to the online game environment. When the metrics data indicates the over capacity of the server hosts, a request is sent to isolate, remove, disconnect, and un-register surplus game servers from the online game environment to make them available to support the player load in other game titles. Thus, the under capacity indicates the increase in the player count and a need to add additional server hosts, while the over capacity indicates the decrease in the player count, and a need to remove surplus server hosts.

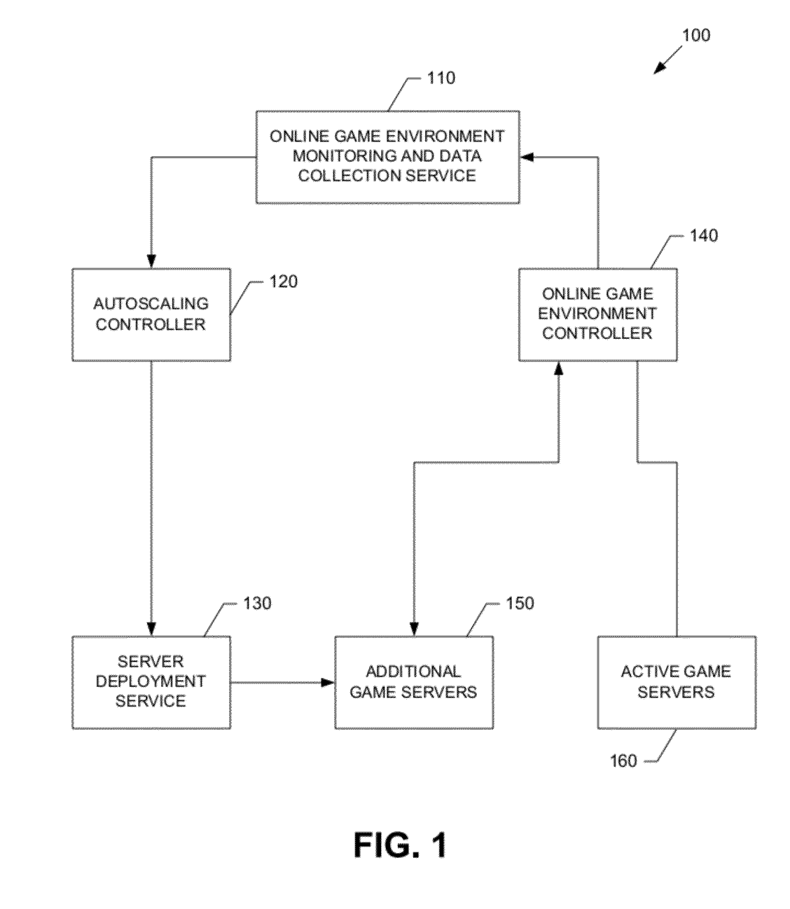

FIG. 1 is a block diagram of a resource management system 100 for managing resources of server hosts in an online game environment in accordance with one implementation of the present invention. In particular, FIG. 1 is a block diagram illustrating an auto-scaling up process of the server hosts. In the illustrated implementation of FIG. 1, the resource management system 100 includes an online game environment controller 140, an online game environment monitoring and data collection service 110, an auto-scaling controller 120, and a server deployment service 130.

The online game environment controller 140 monitors and tracks players, games and lobbies in the online game environment, as well as the game servers and lobby servers. The online game environment controller 140 also supports external requests to change the state of the online game environment using the web interface and can isolate game servers to substantially reduce the impact to the player experience.

The online game environment monitoring and data collection service 110 monitors and collects system metrics data related to server loading (e.g., how many players are online). The auto-scaling controller 120 processes and analyzes the system metrics data collected by the online game environment monitoring and data collection service 110. The auto-scaling controller 120 also makes scaling decisions based on configurable thresholds and rules defined on a per-game-title basis. For example, the auto-scaling controller 120 analyzes the system metrics, and if it determines that the player count is rising, then the controller 120 sends a request to the server deployment service 130 to locate and deploy N additional game servers 150 in addition to the currently active game servers 160 to support the increasing player load. The server deployment service 130 controls the deployment, initiation, and termination of game servers. The service 130 can interact with servers hosted on dedicated hosts as well as cloud-based hosts. Once the server deployment service 130 starts the N additional game servers 150, the servers 150 are connected and registered to the online game environment and are made available to support the player load.

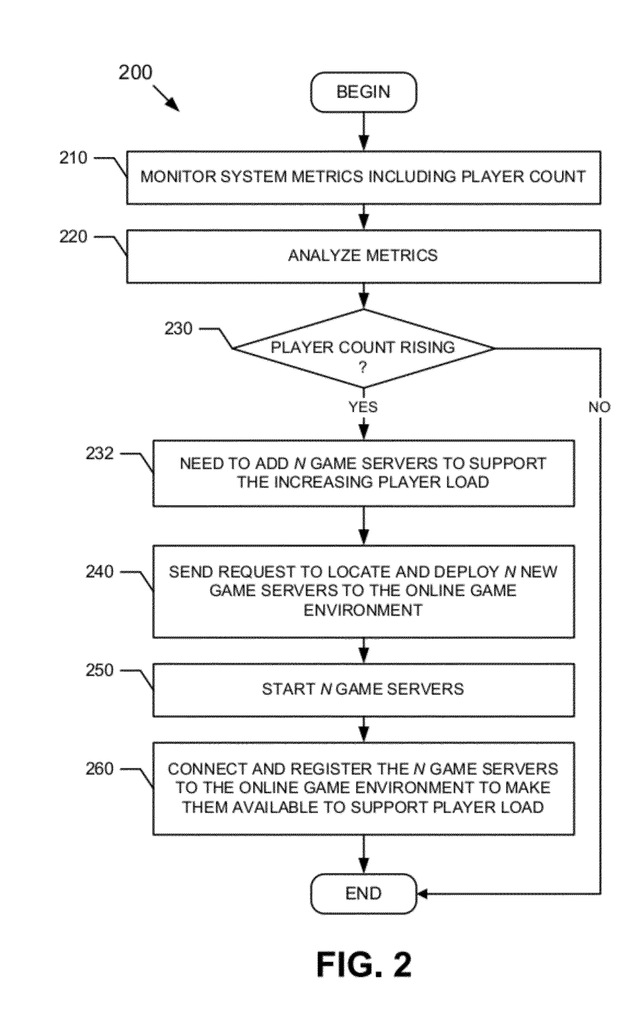

FIG. 2 is a flowchart 200 illustrating a process for managing resources of server hosts in an online game environment in accordance with one implementation of the present invention. In particular, FIG. 2 illustrates an auto-scaling up process of the server hosts. In the illustrated implementation of FIG. 2, the system metrics including a player count is monitored, at box 210. The collected data is then processed and analyzed, at box 220. A determination is made, at box 230, whether the player count is rising or not. If it is determined that the player count is rising which means that N additional game servers are needed to support the increasing player load (see box 232), then a request is sent, at box 240, to locate and deploy N additional game servers to the online game environment. At box 250, the N additional game servers are started, and the servers are connected and registered, at box 260, to the online game environment to make them available to support the player load.

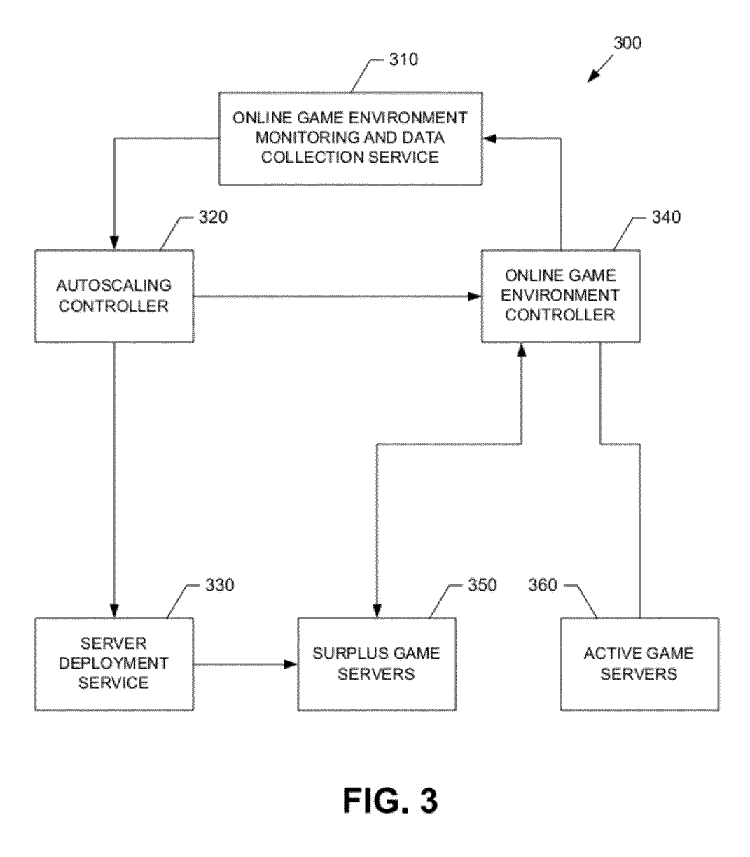

FIG. 3 is a block diagram of a resource management system 300 for managing resources of server hosts in an online game environment in accordance with another implementation of the present invention. In particular, FIG. 3 is a block diagram illustrating an auto-scaling down process of the server hosts. In the illustrated implementation of FIG. 3, the resource management system 300 includes an online game environment controller 340, an online game environment monitoring and data collection service 310, an auto-scaling controller 320, and a server deployment service 330.

The online game environment controller 340 monitors and tracks players, games and lobbies in the online game environment, as well as the game servers and lobby servers. The online game environment controller 340 also supports external requests to change the state of the online game environment using the web interface and can isolate game servers to substantially reduce the impact to the player experience.

The online game environment monitoring and data collection service 310 monitors and collects system metrics data related to server loading (e.g., how many players are online). The auto-scaling controller 320 processes and analyzes the system metrics data collected by the online game environment monitoring and data collection service 310. The auto-scaling controller 320 also makes scaling decisions based on configurable thresholds and rules defined on a per-game-title basis. For example, the auto-scaling controller 320 analyzes the system metrics, and if it determines that the player count is falling, then the controller 320 sends a request to the server deployment service 330 to isolate and remove N surplus game servers 350 from the load balancing pool of available servers, leaving remaining servers as active game servers 360. The server deployment service 330 controls the deployment, initiation, and termination of game servers. The service 330 sends a request to shutdown the N surplus game servers. Once the server deployment service 330 stops the N surplus game servers 350, the servers 350 are disconnected and un-registered from the online game environment, and are made available to support the player load in other game titles.

In one implementation, the server deployment service includes a registration module to locate, deploy, connect, and register additional game servers to support an increasing player load, when the player count increases. Further, the auto-scaling controller includes an interface that requests the online game environment controller to isolate, remove, and disconnect surplus game servers from a load balancing pool of available servers, when the player count decreases.

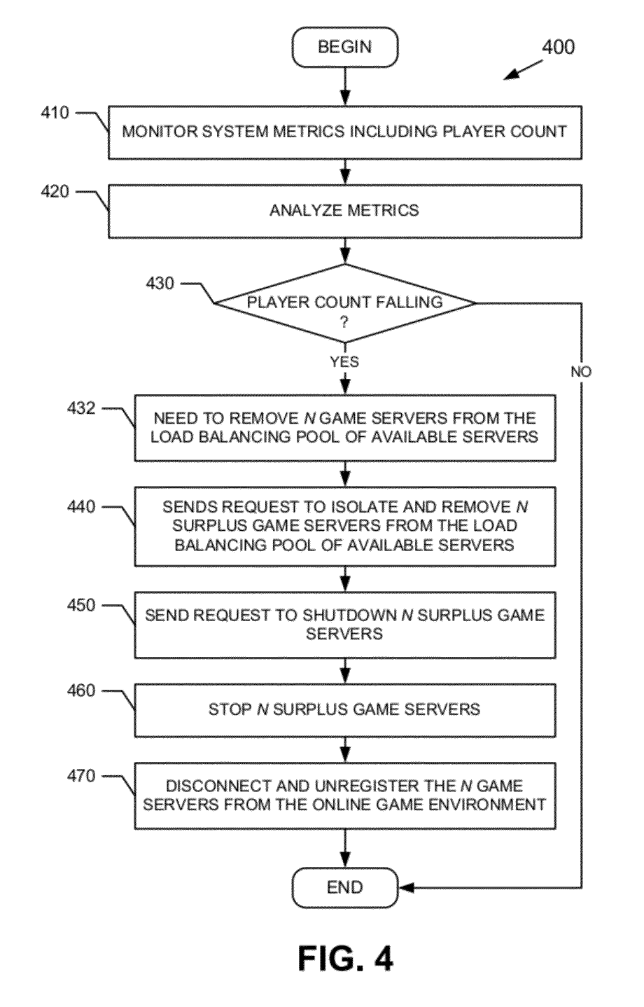

FIG. 4 is a flowchart 400 illustrating a process for managing resources of server hosts in an online game environment in accordance with one implementation of the present invention. In particular, FIG. 4 illustrates an auto-scaling down process of the server hosts. In the illustrated implementation of FIG. 4, the system metrics including a player count is monitored, at box 410. The collected data is then processed and analyzed, at box 420. A determination is made, at box 430, whether the player count is falling or not. If it is determined that the player count is falling which means that N surplus game servers need to be removed from the load balancing pool of available servers (see box 432), then a request is sent, at box 440, to isolate and remove N surplus game servers from the online game environment due to over capacity. At box 450, a request is sent to shutdown the N surplus game servers. The N surplus game servers are stopped, at box 460, and the servers are disconnected and un-registered, at box 470, from the online game environment to make them available to support the player load in other game titles.

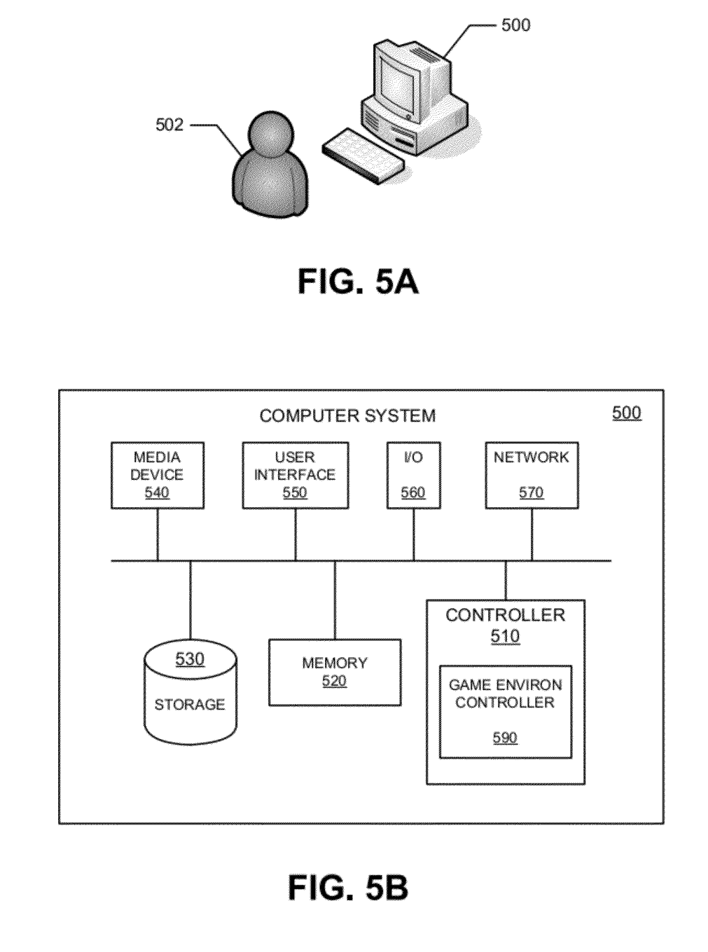

FIG. 5A illustrates a representation of a computer system 500 and a user 502. The user 502 uses the computer system 500 to manage resources of server hosts in an online game environment. The computer system 500 stores and executes a resource management system 590.

FIG. 5B is a functional block diagram illustrating the computer system 500 hosting the resource management system 590. The controller 510 is a programmable processor and controls the operation of the computer system 500 and its components. The controller 510 loads instructions (e.g., in the form of a computer program) from the memory 520 or an embedded controller memory (not shown) and executes these instructions to control the system. In its execution, the controller 510 provides the resource management system 590 as a software system. Alternatively, this service can be implemented as separate hardware components in the controller 510 or the computer system 500.

Memory 520 stores data temporarily for use by the other components of the computer system 500. In one implementation, memory 520 is implemented as RAM. In one implementation, memory 520 also includes long-term or permanent memory, such as flash memory and/or ROM.

Storage 530 stores data temporarily or long term for use by other components of the computer system 500, such as for storing data used by the resource management system 590. In one implementation, storage 530 is a hard disk drive.

The media device 540 receives removable media and reads and/or writes data to the inserted media. In one implementation, for example, the media device 540 is an optical disc drive.

The user interface 550 includes components for accepting user input from the user of the computer system 500 and presenting information to the user. In one implementation, the user interface 550 includes a keyboard, a mouse, audio speakers, and a display. The controller 510 uses input from the user to adjust the operation of the computer system 500.

The I/O interface 560 includes one or more I/O ports to connect to corresponding I/O devices, such as external storage or supplemental devices (e.g., a printer or a PDA). In one implementation, the ports of the I/O interface 560 include ports such as: USB ports, PCMCIA ports, serial ports, and/or parallel ports. In another implementation, the I/O interface 560 includes a wireless interface for communication with external devices wirelessly.

The network interface 570 includes a wired and/or wireless network connection, such as an RJ-45 or “Wi-Fi” interface (including, but not limited to 802.11) supporting an Ethernet connection.

The computer system 500 includes additional hardware and software typical of computer systems (e.g., power, cooling, operating system), though these components are not specifically shown in FIG. 5B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of managing resources of server hosts in an online game environment, the method comprising:
monitoring metrics data of the online game environment including configurable thresholds and rules defined for a game title;
processing and analyzing the metrics data;
determining whether the metrics data indicates an over or under capacity of the server hosts in the online game environment;
sending a first request to locate, deploy, connect, and register additional game servers to the online game environment to support increasing load, when the metrics data indicates the under capacity of the server hosts; and
sending a second request to isolate, remove, disconnect, and un-register surplus game servers from the online game environment to make them available to support the player load in other game titles, when the metrics data indicates the over capacity of the server hosts.

2. The method of claim 1, wherein the thresholds and rules defined for a game title include a player count.

3. The method of claim 2, wherein the under capacity indicates increase in the player count and a need to add additional server hosts.

4. The method of claim 2, wherein the over capacity indicates decrease in the player count and a need to remove surplus server hosts.

5. The method of claim 1, wherein the second request to isolate and remove surplus game servers comprises
sending commands to isolate the surplus game servers to be de-commissioned and to initially remove the surplus game servers from a list of server hosts to idle in-progress games.

6. The method of claim 5, wherein the second request to disconnect and un-register surplus game servers comprises
shutting down the surplus game servers when the in-progress games are idled.

7. A resource management system to manage resources of server hosts in an online game environment, the system comprising:
an online game environment controller configured to monitor and track players, games, and game servers in the online game environment,
wherein the online game environment controller supports external requests to change the state of the online game environment;
an online game environment monitoring and data collection service configured to monitor and collect system metrics data related to server loading;
an auto-scaling controller configured to process and analyze the system metrics data, and to make scaling decisions based on configurable thresholds and rules defined on a per-game-title basis; and
a server deployment service configured to control deployment, initiation, and termination of the game servers.

8. The system of claim 7, wherein the thresholds and rules include a player count.

9. The system of claim 8, wherein the server deployment service includes a registration module to locate, deploy, connect, and register additional game servers to support an increasing player load, when the player count increases.

10. The system of claim 8, wherein the auto-scaling controller includes an interface that requests the online game environment controller to isolate, remove, and disconnect surplus game servers from a load balancing pool of available servers, when the player count decreases.

11. A non-transitory tangible storage medium storing a computer program for managing resources of server hosts in an online game environment, the computer program comprising executable instructions that cause a computer to:
monitor metrics data of the online game environment including configurable thresholds and rules defined for a game title;
process and analyze the metrics data;
determine whether the metrics data indicates an over or under capacity of the server hosts in the online game environment;
send a first request to locate, deploy, connect, and register additional game servers to the online game environment to support increasing load, when the metrics data indicates the under capacity of the server hosts; and
send a second request to isolate, remove, disconnect, and un-register surplus game servers from the online game environment to make them available to support the player load in other game titles, when the metrics data indicates the over capacity of the server hosts.

12. The non-transitory tangible storage medium of claim 11, wherein the thresholds and rules defined for a game title include a player count.

13. The non-transitory tangible storage medium of claim 12, wherein the under capacity indicates increase in the player count and a need to add additional server hosts.

14. The non-transitory tangible storage medium of claim 12, wherein the over capacity indicates decrease in the player count and a need to remove surplus server hosts.

15. The method of claim 11, wherein executable instructions that cause a computer to send a second request to isolate and remove surplus game servers comprises executable instructions that cause a computer to
send commands to isolate the surplus game servers to be de-commissioned and to initially remove the surplus game servers from a list of server hosts to idle in-progress games.

16. The method of claim 15, wherein executable instructions that cause a computer to send a second request to disconnect and un-register surplus game servers comprises executable instructions that cause a computer to
shut down the surplus game servers when the in-progress games are idled.
